(19) United States
(12) Patent Application Publication
(10) Pub. No.: US 2023/0292246 A1
(43) Pub. Date: Sep. 14, 2023

(54) SYSTEM AND METHOD FOR OPTIMIZING ENERGY IN BATTERY POWERED DEVICES

(71) Applicant: Carrier Corporation, Palm Beach Gardens, FL (US)

(72) Inventors: Satya Dinesh Munjuluri, Hyderabad (IN); Naga Santosh Ranjith Kumar Gowd Kota, Hyderabad (IN); Rakesh Aity, Hyderabad (IN); Sanjeevareddy Neelam, Hyderabad (IN); Nitheesha Vallurupalli, Hyderabad (IN)

(21) Appl. No.: 18/181,763

(22) Filed: Mar. 10, 2023

(30) Foreign Application Priority Data
Mar. 10, 2022 (IN) 202211013073

(51) Int. Cl. H04W 52/02; H04W 8/00

(52) U.S. Cl. CPC H04W 52/0254; H04W 8/005

(57) ABSTRACT

A system and a method for optimizing energy in battery powered wireless devices. A user application is provided on a first device with an interactive feature. A user input to interact with the interactive feature is received on the user application. A data packet is generated in response to the user input on the interactive feature. The data packet is transmitted to a second device. The second device validates the data packet and the second device dynamically changes advertising interval for transmitting a beacon signal to the first device based on the validation of the data packet.

### FOREIGN PRIORITY

This application claims priority to Indian Patent Application No. 202211013073, filed Mar. 10, 2022, and all the benefits accruing therefrom under 35 U.S.C. § 119, the contents of which in its entirety are herein incorporated by reference.

### TECHNICAL FIELD OF INVENTION

The present invention generally relates to wireless technology. More particularly, the invention relates to a system and a method for optimizing energy in battery powered wireless devices.

### BACKGROUND OF THE INVENTION

Wireless communication technologies generate vast amounts of data. The data, that is being created and updated every moment, requires intelligent systems with huge battery lives for supporting these intelligent systems to perform the required tasks without frequent charging or battery replacement.

For example, in the real estate industry, property prices keep fluctuating regularly and such properties may be of interest to prospective home buyers. In most real estate transactions, there are multiple people involved in completing the transaction from prospective buyer, agents, seller, to multiple visitors that visit respective property of interest to check the property. An event of showing a seller's property to a prospective buyer generates an electronic event at a key box, so that relevant agent may access the key box to retrieve key to show the property.

Thus, an automatic system is developed in which the agent or buyer visits the property of interest with a portable communication device, for example a mobile device that communicates with the key box using a short-range wireless communication. Wireless devices may use a large portion of battery life to exchange data.

Therefore, the battery life is a major concern for battery operated products and particularly wirelessly connected devices, for example—Bluetooth enabled devices. Requirement of keeping the devices switched on perpetually, keeps draining the battery. Therefore, there is a need in the art to develop system and methods to save battery life by optimizing energy consumption of the battery.

### SUMMARY OF THE INVENTION

The present disclosure presents a simplified summary of the invention in order to provide a basic understanding of some aspects of the invention. This summary is not an extensive overview of the present invention. It is not intended to identify the key/critical elements of the invention or to delineate the scope of the invention. Its sole purpose is to present some concept of the invention in a simplified form as a prelude to a more detailed description of the invention presented later.

Various embodiments of the invention describe a method for optimizing energy in battery powered wireless devices. The method comprises steps of providing a user application on a first device with an interactive feature. The method also comprises steps of receiving a user input to interact with the interactive feature on the user application. The method further comprises steps of generating a data packet in response to the user input on the interactive feature. The method further comprises steps of transmitting the data packet to a second device. The second device validates the data packet and the second device dynamically changes advertising interval for transmitting a beacon signal to the first device based on the validation of the data packet.

In an embodiment of the invention, the first device and the second device are communicably coupled using a Bluetooth.

In another embodiment of the invention, the interactive feature is an icon which is executed on receiving user input in the form of one or more gestures.

In still another embodiment of the invention, the data packet comprises a unique identifier indicating identity of the first device.

In another embodiment of the invention, the second device validates the data packet by matching the unique identifier of the first device with a prestored unique identifier.

In yet another embodiment of the invention, the second device matches the unique identifier of the first device after establishing a communication with a cloud.

In another embodiment of the invention, on validation of the data packet, the first device is connected with the second device and the advertising interval of the beacon signal is reduced.

In yet another embodiment of the invention, on invalidation of the data packet, the advertising interval of the beacon signal is not changed.

In yet another embodiment of the invention, the first device is a mobile device and the second device is a key box.

Various embodiments of the invention describe a system for optimizing energy in battery powered wireless devices. The system comprises a first device configured with a user application and the user application comprises an interactive feature. The first device is configured to receive a user input to interact with the interactive feature on the user application. The first device is configured to generate a data packet in response to the user input on the interactive feature. The first device is configured to transmit the data packet to a second device. The second device is configured to receive the data packet. The second device is configured to validate the data packet. Further, the second device dynamically changes advertising interval for transmitting a beacon signal to the first device based on the validation of the data packet.

In an embodiment of the invention, the first device and the second device are communicably coupled using a Bluetooth.

In another embodiment of the invention, the interactive feature is an icon which is executed on receiving user input in the form of one or more gestures.

In another embodiment of the invention, the data packet comprises a unique identifier indicating identity of the first device.

In yet another embodiment of the invention, the second device validates the data packet by matching the unique identifier of the first device with a prestored unique identifier.

In another embodiment of the invention, the second device matches the unique identifier of the first device after establishing a communication with a cloud.

In yet another embodiment of the invention, on validation of the data packet, the advertising interval of the beacon signal is reduced.

In yet another embodiment of the invention, on invalidation of the data packet, the advertising interval of the beacon signal is not changed.

In yet another embodiment of the invention, the first device is a mobile device and the second device is a key box.

Various embodiments of the invention describe a computer readable medium comprising one or more processors and a memory coupled to the one or more processors. Further, the memory stores instructions executed by the one or more processors. The one or more processors are configured to enable a user application on a first device comprising an interactive feature. The one or more processors are configured to receive a user input to interact with the interactive feature on the user application. The one or more processors are configured to generate a data packet in response to the user input on the interactive feature. The one or more processors are configured to transmit the data packet to a second device and the second device is configured to receive and validate the data packet. The second device dynamically changes advertising interval for transmitting a beacon signal to the first device based on the validation of the data packet. In an embodiment of the invention, the computer readable medium comprising one or more processors and a memory coupled to the one or more processors. The memory storing instructions executed by the one or more processors, the one or more processors configured to enable a user application on a first device comprising an interactive feature. The one or more processors are configured to receive a user input to interact with the interactive feature on the user application, generate a data packet in response to the user input on the interactive feature, and transmit the data packet to a second device, wherein the second device is configured to receive and validate the data packet. The second device dynamically changes advertising interval for transmitting the beacon signal to the first device based on the validation of the data packet.

In yet another embodiment of the invention, the first device is a mobile device and the second device is a keybox.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Other aspects, advantages, and salient features of the invention will become apparent to those skilled in the art from the following detailed description, which taken in conjunction with the annexed drawings, discloses exemplary embodiments of the invention.

### BRIEF DESCRIPTION OF THE DRAWINGS

Some of the objects of the invention have been set forth above. These and other objects, features, aspects and advantages of the present invention will become better understood with regard to the following description, appended claims and accompanying drawings where:

FIG. 1 depicts an exemplary system diagram in accordance with the invention of the present application.

FIG. 2 depicts an exemplary block diagram of a first device in accordance with the invention of the present application.

FIG. 3 depicts an exemplary block diagram of a second device in accordance with the invention of the present application.

FIG. 4 depicts a flow diagram of the system in accordance with the invention of the present application.

Corresponding reference numerals indicate corresponding parts throughout the drawings.

### DETAILED DESCRIPTION OF THE INVENTION

The following detailed description should be read with reference to the drawings in which similar elements in different drawings are numbered the same. The drawings, which are not necessarily to scale, depict illustrative embodiments and are not intended to limit the scope of the invention. Although examples of construction, dimensions, and materials are illustrated for the various elements, those skilled in the art will recognize that many of the examples provided have suitable alternatives that may be utilized.

Described herein is the technology with a system and a method for optimizing energy in battery powered wireless devices. The present invention describes providing a user application on a first device with an interactive feature. A user input is received to interact with the interactive feature on the user application. A data packet is generated in response to the user input on the interactive feature. The data packet is then transmitted to a second device. The second device validates the data packet and the second device dynamically changes advertising interval for transmitting a beacon signal to the first device based on the validation of the data packet.

The embodiments of the invention may be used to optimize energy of battery powered devices. The battery powered devices may be switched into an active mode only when the incoming data packet is validated. For remaining period, the battery powered device may remain in an inactive mode that may optimize battery consumption. By increasing an advertisement interval, battery performance may be improved. Thus, battery life of the battery powered devices may increase by implementing present technology and the battery powered devices may not be required to change their battery frequently. Also, no manual intervention may be required to change the advertisement interval. No technician may be required for manually changing the advertisement interval. Thus, key boxes may become smart and save battery when not in use.

As used herein, the terms “first” and “second” preceding an element name, e.g., first device, second device, are used for identification purposes to distinguish between similar or related elements, results or concepts, and are not intended to necessarily imply order, nor are the terms “first” and “second” intended to preclude the inclusion of additional similar or related elements, results or concepts, unless otherwise indicated. It will be understood that the term first device may be one or more of a portable communication device (sometimes referred as a mobile device, a tablet or a portable transponder) that communicates with the second device.

As used herein, the second device may be one or more of the electronic key box (hereinafter interchangeably called lockbox or key box).

As used herein, an interactive feature (edetect option) may be a click button, an icon on a user application configured on the first device such as the mobile device. The interactive feature is executed on receiving user input in the form of one or more gestures etc. The interactive feature may be used to detect Bluetooth beacon signals on searching after execution of the interactive feature.

As used herein, the first device and the second device may communicate among themselves using short range wireless communication technologies such as Bluetooth, infrared, near field communication, ultra-band, Zigbee etc. Moreover, the first device and the second device may communicate with cloud/server using cellular network or local, area network (LAN), Wide Area Network (WAN) and the like known to a person skilled in the art.

As used herein, the features of the invention disclosed herein may be implemented in software and may be executed using hardware to implement the technology described herein.

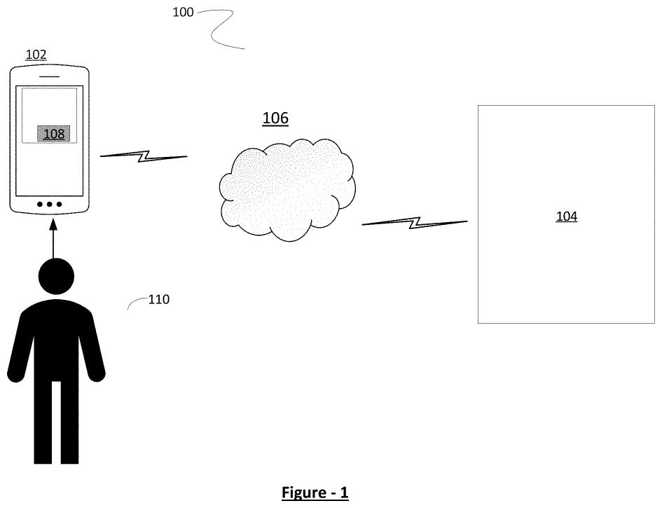

FIG. 1 illustrates system 100 in accordance with the invention. In some embodiments, the system 100 comprises a first device 102 and a second device 104. When the first device 102 comes in proximity of the second device 104, communication may be established between the first device 102 and the second device 104. The first device 102 is configured with a user application installed on the first device 102 and the user application comprises an interactive feature 108. The first device 102 is configured to receive a user input to interact with the interactive feature 108 on the user application. The first device 102 is configured to generate a data packet in response to the user input on the interactive feature 108. The first device 102 then transmits the data packet to the second device 104. The data packet comprises a unique identifier indicating an identity of the first device 102. The second device 104 receives the data packet and further validates the data packet. On validating the data packet, the second device 104 dynamically changes advertisement interval for transmitting a beacon signal to the first device 102.

The second device 104 may operate on the battery and consume energy from the battery. It is known that the power consumption due to Bluetooth communication may be adjusted by tuning configurations related to advertisements and connection mode of respective devices. The advertisements are used by a Bluetooth Low Energy technology (BLE) device to broadcast data packets to devices in vicinity. The second device 104 receives the data packets transmitted from the first device 102 and validates the data packet by matching the unique identifier of the first device 102 with a prestored unique identifier. The second device 104 may also match the unique identifier of the first device 102 for validation.

In an embodiment of the invention, the second device 104 may validate the data packet by matching the unique identifier with the prestored unique identifier stored on cloud 106. The second device 104 may establish a communication with the cloud 106 using a suitable communication network. In case of correct data packet being received at the second device, the second device 104 may validate the received data packet. On determining that the data packet is valid, the advertisement interval of transmitting beacon signal to the first device 102 is reduced. However, in case of incorrect data packet being received at the second device 104, the second device 104 may not validate the received data packet. Thus, on invalidation of the data packet, the advertisement interval of the beacon signal may not change and the second device 104 may continue to transmit beacon signal with large time interval. Therefore, by modifying the advertisement interval, the energy consumed by the battery may be optimized suitably for the second device 104, thereby lowering the power consumption, speeding up connections, and improve reliability.

It is to be noted that the advertisement interval of transmitting the beacon signals to the first device 102 may be changed by changing a data structure stored in a second memory (explained below) of the second device 104 (e.g. keybox). In other words, there may be a logic implemented for changing data structure for the advertisement interval.

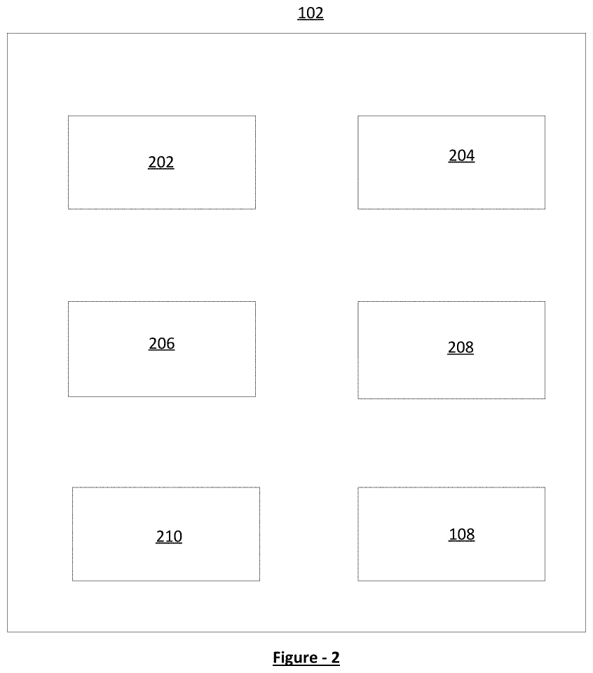

FIG. 2 illustrates a block diagram of the first device 102. The first device 102 comprises a first transmitter 202, a first receiver 204, a first processor 206, a first memory 208, a first Bluetooth module 210 and also comprises a user application having the interactive feature 108. The user initiates a communication by executing the interactive feature 108 on the user application. On executing the interactive feature 108, a data packet is generated at the first device 102 using the first processor 206 that may be transmitted, using the first transmitter 202 to the second device 104 for validation. The first Bluetooth module 210 facilitates transmission of the data packet from the first device 102 to the second device 104 with the help of Bluetooth technique. The second device 104, after validating the data packet sent from the first device 102, dynamically changes advertisement interval for transmitting the beacon signal to the first device 102. Any beacon signal transmitted from the second device 104 is received at the first receiver 204.

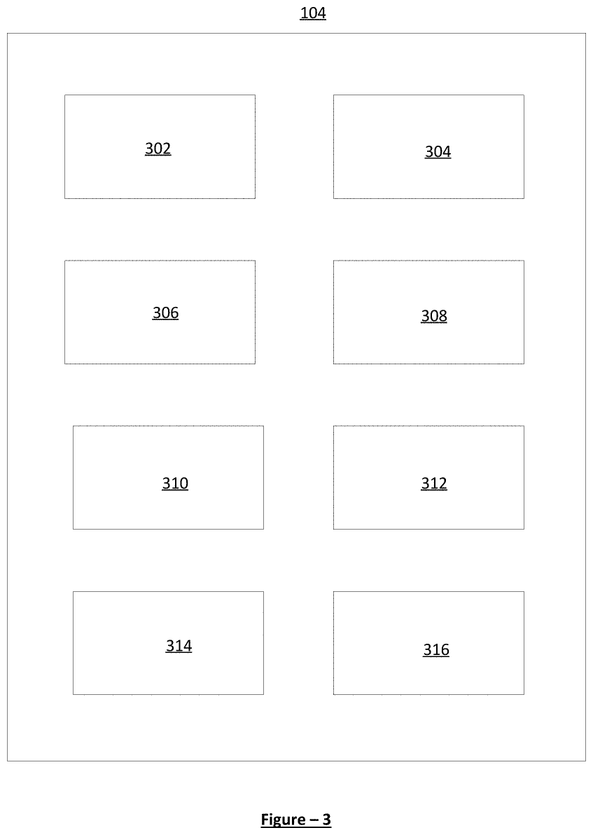

FIG. 3 illustrates a block diagram of the second device 104. The second device 104 comprises a second transmitter 302, a second receiver 304, a second processor 306, the second memory 308, a second Bluetooth module 310, a validation unit 312 and a battery module 314 and an electronic lock 316. The second device 104 receives the data packet transmitted from the first device 102 at the second receiver 304. On receiving the data packet, the second device 104 validates the data packet using a pre stored unique identifier stored in the second memory 308 using the second processor 306 and the validation unit 312. On validating the data packet, the second device 104 dynamically changes advertisement interval for transmitting the beacon signal to the first device 102 on the second Bluetooth module 310. The second Bluetooth module 310 facilitates transmission of the beacon signal from the second device 104 to the first device 102 with modified advertisement interval. The different embodiments of the invention are described herein using an example. Let us assume the default advertising interval for the key box is 1000 ms.

On receiving a valid data packet at the key box, electronic handshake signals may be exchanged between the user application on a mobile device of the user. Due to exchange of handshaking signals between the key box and the mobile device, the key box may turn into an active state. The key box may be configured to reduce the advertisement interval of the Bluetooth settings to 32 ms once the handshaking takes place between the key box and the mobile device that may result in faster information exchange. The reduced advertisement rate may be valid throughout a session between which the key box and the mobile device are in connected state. After the session, the advertisement interval may again increase from 32 ms to 1000 ms. By switching the key box to active mode only during the exchange of data, the key box may optimize its average power consumption as low as 93%. However, when no data exchange takes place, the key box may remain in inactive mode and may continue to operate at 1000 ms. The advertisement interval of the beacon signal may be automatically changed and may vary depending upon the user requirements. Thus, the present invention may greatly reduce the battery consumption by regulating advertising intervals.

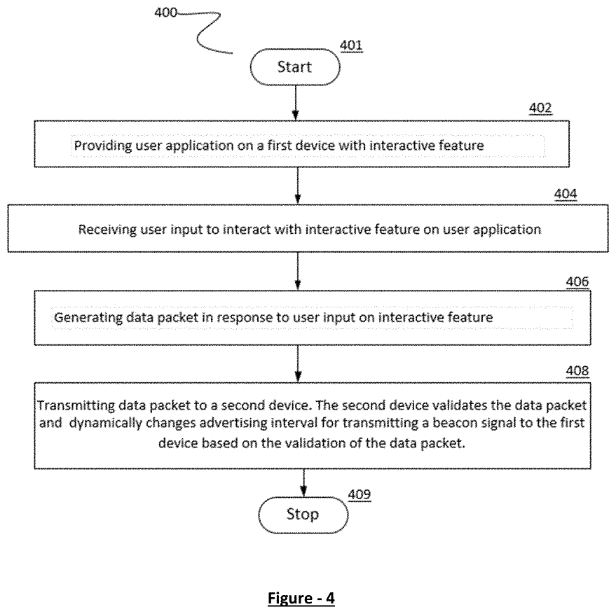

FIG. 4 is an exemplary flowchart illustrating a method to perform the invention. In some embodiment, a method comprises a step 402 for providing the user application on the first device 102 with the interactive feature 108. The method comprises a step 404 of receiving the user input to interact with the interactive feature 108 on the user application. The method further comprises a step 406 of generating the data packet in response to the user input on the interactive feature 108. The method also comprises a step 408 of transmitting the data packet to the second device 104. The second device 104 validates the data packet and the second device 104 dynamically changes the advertisement interval for transmitting a beacon signal to the first device 102 based on the validation of the data packet. The features of the invention for the different method steps are already described in detail with respect to FIG. 1. Various other features described above in FIG. 1 and FIG. 2 are part of the method of performing the invention and are not described herein to maintain brevity.

The present invention is applicable in any industry/field that is well known in the art and where an equipment is utilized. The embodiments of the invention discussed herein are exemplary and various modifications and alterations to a person skilled in the art are within the scope of the invention.

In one embodiment of the invention, the invention can be operated using the one or more computer readable devices. The one or more computer readable devices can be associated with a system 100. A computer readable medium comprises one or more processors and a memory coupled to the one or more processors, the memory stores instructions executed by the one or more processors. The one or more processors are configured to enable a user application on a first device 102 comprising an interactive feature 108. The one or more processors are configured to receive a user input to interact with the interactive feature on the user application. The one or more processors are configured to generate a data packet in response to the user input on the interactive feature 108. The one or more processors are configured to transmit the data packet to a second device 104 and the second device 104 is configured to receive and validate the data packet. The second device dynamically changes advertising interval for transmitting a beacon signal to the first device 104 based on the validation of the data packet.

Exemplary computer readable media includes flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Computer storage media are tangible and mutually exclusive to communication media. Computer storage media are implemented in hardware and exclude carrier waves and propagated signals. Computer storage media for purposes of this invention are not signals per se. Exemplary computer storage media include hard disks, flash drives, and other solid-state memory. In contrast, communication media typically embody computer readable instructions, data structures, program modules, or other data in a modulated data signal such as a carrier wave or other transport mechanism and include any information delivery media.

Although described in connection with an exemplary computing system environment, examples of the invention are capable of implementation with numerous other general purposes or special purpose computing system environments, configurations, or devices.

Examples of the invention may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the Figures and described herein. Other examples of the invention may include different computer-executable instructions or components having more or less functionality than illustrated and described herein. Aspects of the invention transform a general-purpose computer into a special-purpose computing device when configured to execute the instructions described herein.

The order of execution or performance of the operations in examples of the invention illustrated and described herein is not essential, unless otherwise specified. That is, the operations may be performed in any order, unless otherwise specified, and examples of the invention may include additional or fewer operations than those disclosed herein. For example, it is contemplated that executing or performing a particular operation before, contemporaneously with, or after another operation is within the scope of aspects of the invention.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “data store,” “data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

When introducing elements of aspects of the invention or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C”.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method comprising:
providing a user application on a first device with an interactive feature;
receiving a user input to interact with the interactive feature on the user application;
generating a data packet in response to the user input on the interactive feature;
transmitting the data packet to a second device,
wherein the second device validates the data packet, wherein the second device dynamically changes advertising interval for transmitting a beacon signal to the first device based on the validation of the data packet.

2. The method as claimed in claim 1, wherein the first device and the second device are communicably coupled using a Bluetooth.

3. The method as claimed in claim 1, wherein the interactive feature is an icon which is executed on receiving user input using at least one gestures.

4. The method as claimed in claim 1, wherein the data packet comprises a unique identifier indicating identity of the first device.

5. The method as claimed in claim 4, wherein the second device validates the data packet by matching the unique identifier of the first device with a prestored unique identifier.

6. The system as claimed in claim 4, wherein the second device matches the unique identifier of the first device after establishing a communication with a cloud.

7. The method as claimed in claim 1, wherein on validation of the data packet, the first device is connected with the second device and the advertising interval of the beacon signal is reduced.

8. The method as claimed in claim 1, wherein on invalidation of the data packet, the advertising interval of the beacon signal is not changed.

9. The system as claimed in claim 1, wherein the first device is a mobile device and the second device is a keybox.

10. A system comprising:
a first device configured with a user application, wherein the user application comprises an interactive feature, the first device configured to:
receive a user input to interact with the interactive feature on the user application;
generate a data packet in response to the user input on the interactive feature;
transmit the data packet to a second device; and
a second device configured to:
receive the data packet; and
validate the data packet,
wherein the second device dynamically changes advertising interval for transmitting a beacon signal to the first device based on the validation of the data packet.

11. The system as claimed in claim 10, wherein the first device and the second device are communicably coupled using a Bluetooth.

12. The system as claimed in claim 10, wherein the interactive feature is an icon which is executed on receiving user input using at least one gestures.

13. The system as claimed in claim 10, wherein the data packet comprises a unique identifier indicating identity of the first device.

14. The system as claimed in claim 13, wherein the second device validates the data packet by matching the unique identifier of the first device with a prestored unique identifier.

15. The system as claimed in claim 13, wherein the second device matches the unique identifier of the first device after establishing a communication with a cloud.

16. The system as claimed in claim 10, wherein on validation of the data packet, the advertising interval of the beacon signal is reduced.

17. The system as claimed in claim 10, wherein on invalidation of the data packet, the advertising interval of the beacon signal is not changed.

18. The system as claimed in claim 10, wherein the first device is a mobile device and the second device is a keybox.

19. A computer readable medium comprising one or more processors and a memory coupled to the one or more processors, the memory storing instructions executed by the one or more processors, the one or more processors configured to:
enable a user application on a first device comprising an interactive feature;
receive a user input to interact with the interactive feature on the user application;
generate a data packet in response to the user input on the interactive feature;
transmit the data packet to a second device, wherein the second device is configured to receive and validate the data packet,
wherein the second device dynamically changes advertising interval for transmitting a beacon signal to the first device based on the validation of the data packet.

20. The computer readable medium as claimed in claim 19, wherein the first device is a mobile device and the second device is a keybox.
